(19) United States
(12) Patent Application Publication
(10) Pub. No.: US 2026/0312673 A1
(43) Pub. Date: Oct. 8, 2026

(54) UNICAST AND BROADCAST COMMUNICATIONS USING PHASED-ARRAY ANTENNA

(71) Applicant: Viasat, Inc., Carlsbad, CA (US)

(72) Inventor: James E. Petranovich, La Jolla, CA (US)

(21) Appl. No.: 18/998,290

(22) PCT Filed: Jul. 27, 2022
(86) PCT No.: PCT/US2022/038600

§ 371 Date: Jan. 24, 2025

(51) Int. Cl. H04B 7/185; H01Q 1/28; H01Q 21/00

(52) U.S. Cl. CPC H04B 7/18523; H01Q 1/288; H01Q 21/00; H04B 7/18513; H04B 7/18515; H04B 7/18582

(57) ABSTRACT

Methods, systems, and devices for unicast and broadcast communications using single-beam phased-array antenna system are described. For instance, a terminal may communicate with a first satellite via a single-beam phased-array antenna system during a first set of time slots, where the first set of time slots is associated with transmission of a first set of packets associated with a broadcast stream transmitted by a second satellite. The terminal may receive, from the second satellite, a second set of packets associated with the broadcast stream via the single-beam phased-array antenna system during a second set of time slots. The terminal may decode the second set of packets associated with the broadcast stream in the second set of time slots, may recover the broadcast stream contained within the first and second plurality of packets based on applying a function to one or more of the second set of packets, and may output the recovered broadcast stream.

### CROSS REFERENCE

The present Application is a 371 national phase filing of International Patent Application No. PCT/US2022/038600 by PETRANOVICH entitled, “UNICAST AND BROADCAST COMMUNICATIONS USING PHASED-ARRAY ANTENNA”, filed Jul. 27, 2022, which is assigned to the assignee hereof and is hereby incorporated by reference in its entirety.

### FIELD OF TECHNOLOGY

The following relates to one or more systems for communications, including unicast and broadcast communications using phased-array antenna.

### BACKGROUND

The following relates generally to communications, including unicast and broadcast communications using phased-array antenna.

Communications devices may communicate using phased array antennas. A phased array antenna may include a set of antenna elements, and may adjust magnitude or phase of component signals communicated via the set of antenna elements to form a beam directed to a target device. In some cases, to communicate with more than one target device, a device may support multiple concurrent beams with a single phased array antenna (e.g., a multi-beam antenna). However, multi-beam antennas may be associated with a greater cost (e.g., due to a larger size, differences in types of material, an increased amount of power used in operation) and/or a greater complexity (e.g., more complex hardware or software being used to process signals from the multi-beam antenna) as compared to single-beam antennas.

### BRIEF DESCRIPTION OF THE DRAWINGS

FIG. 1 illustrates an example of a network that supports unicast and broadcast communications using phased-array antenna in accordance with examples as disclosed herein.

FIG. 2 illustrates an example of a communication scheme that supports unicast and broadcast communications using phased-array antenna in accordance with examples as disclosed herein.

FIG. 3 illustrates an example of an antenna system that supports unicast and broadcast communications using phased-array antenna in accordance with examples as disclosed herein.

FIG. 4 illustrates an example of a beamforming scheme that supports unicast and broadcast communications using phased-array antenna in accordance with examples as disclosed herein.

FIG. 5 illustrates an example of a duty cycle adjustment scheme that supports unicast and broadcast communications using phased-array antenna in accordance with examples as disclosed herein.

FIGS. 6 and 7 show flowcharts illustrating a method or methods that support unicast and broadcast communications using phased-array antenna in accordance with examples as disclosed herein.

### DETAILED DESCRIPTION

It may be desirable for a terminal to receive signals from multiple satellites. For example, a terminal may be connected with one or more user devices that may communicate different types of information. For example, the terminal may be on a vehicle and one or more users within the vehicle may want to perform unicast network access communication with a first satellite while other users within the vehicle may want access content that is transmitted by a second satellite in a broadcast stream. In some examples, a multi-beam antenna system may be used to concurrently communicate with the multiple satellites. For example, a terminal may communicate one or more unicast messages with the first satellite and may receive a broadcast stream from the second satellite simultaneously using a first beam and a second beam, respectively. A multi-beam antenna system may include more than one antenna, or may include a single antenna (e.g., phased array antenna) capable of supporting multiple concurrent beams. The multi-beam antenna system may include multiple transceivers, or may include a single transceiver capable of supporting multiple beams concurrently. Communicating transmissions using multi-beam antennas may be associated with a greater cost (e.g., due to a larger size, differences in types of material, an increased amount of power used in operation) and/or a greater complexity (e.g., more complex hardware or software being used to process signals from the multi-beam antenna) as compared to single-beam antennas. However, supporting communication with multiple satellites for various forms of communication (e.g., unicast and broadcast) with a single-beam antenna system (e.g., a system whose one or more antennas, transceiver, modem, beamforming network, or any combination thereof are capable of operating together or separately to form a single beam at a given time) may result in disruption to content.

The present disclosure describes techniques that enable a terminal to receive a broadcast stream and communicate one or more unicast messages using a single-beam antenna system without disrupting the content of the broadcast stream for communication of unicast messages. For instance, a ground station may indicate, to the terminal, a first set of time slots over which the terminal is to communicate the one or more unicast messages with the first satellite and/or a second set of time slots over which the terminal is to receive the broadcast stream. The second satellite may encode packets of the broadcast stream with a level of redundancy using a code (e.g., a linear rateless code) such that the broadcast stream may be decodable using packets of the broadcast stream received over the second set of time slots. In some cases, the terminal may include a phased-array antenna, and may use a first beam in order to communicate the one or more unicast messages over the first set of time slots (e.g., thus missing any packets of the broadcast stream communicated over the first set of time slots) and may use a second beam in order to receive the broadcast stream over a second set of time slots. The terminal may use a single-beam phased-array antenna, and may switch between the first beam for the first set of time slots and the second beam for the second set of time slots. Alternatively, the terminal may have a single transceiver that may be switched between multiple antennas for the first and second sets of time slots. The terminal may use the level of redundancy encoded in the packets received over the second set of time slots to recover the portion of broadcast stream within the packets communicated over at least a portion of the first set of time slots. Accordingly, the terminal may output the entire broadcast stream and communicate the one or more unicast messages.

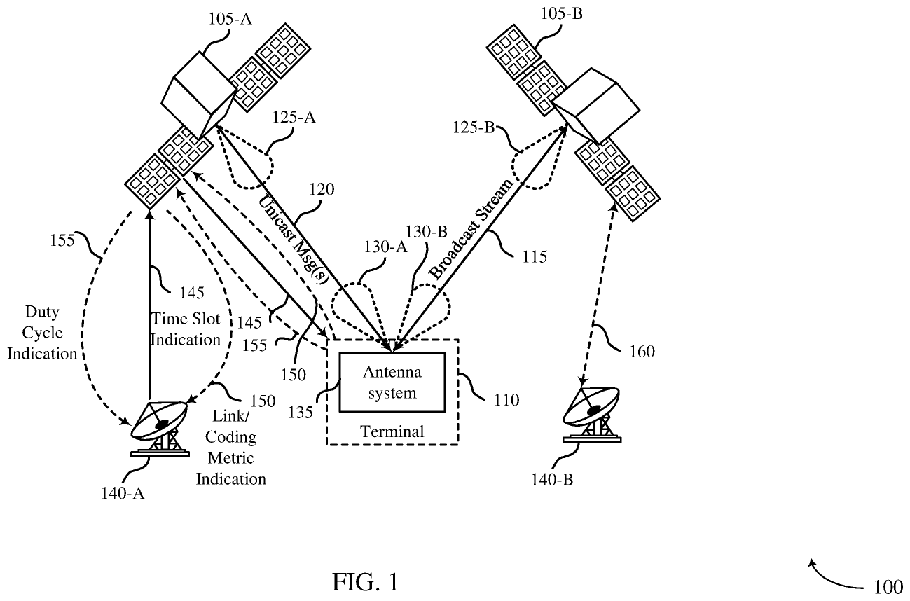

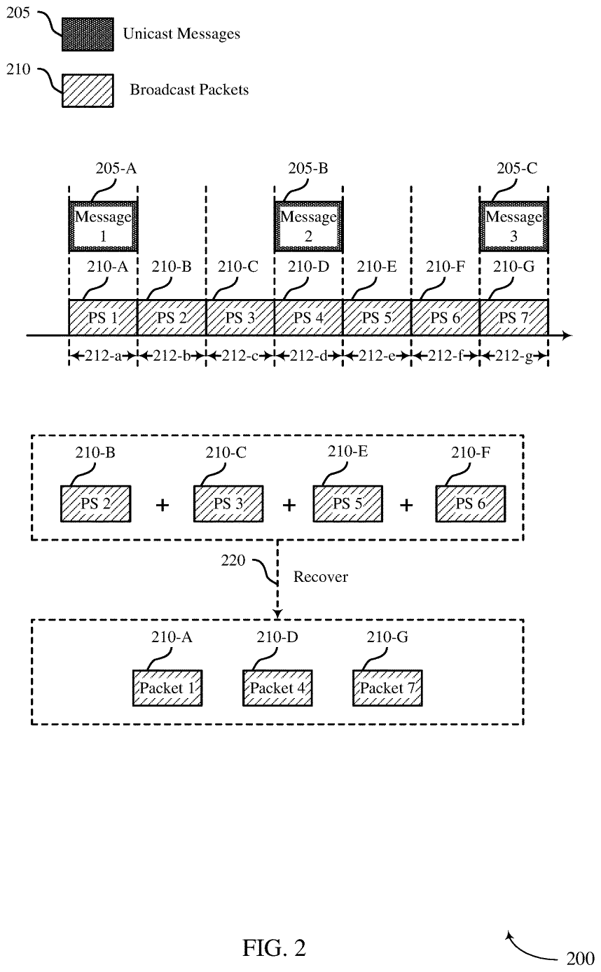

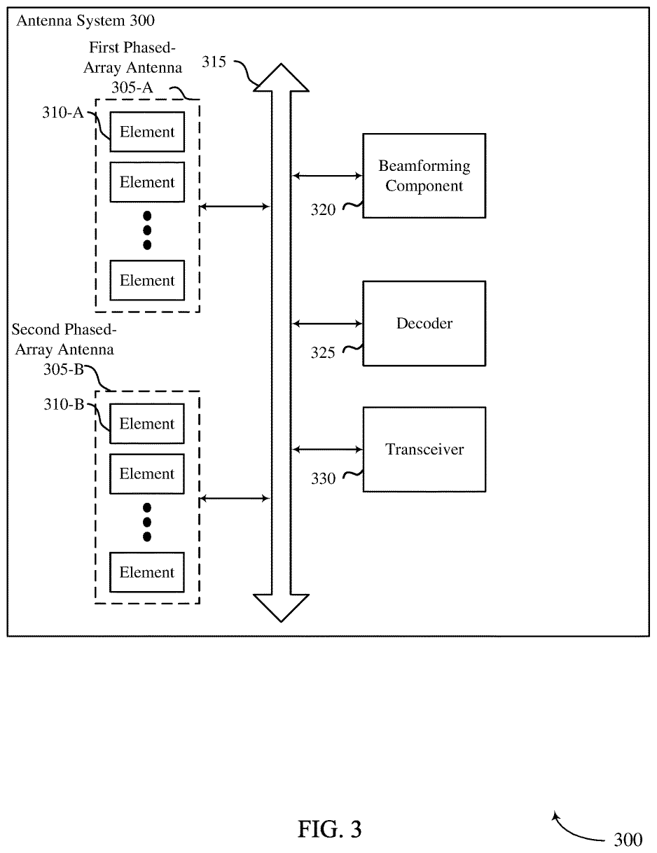

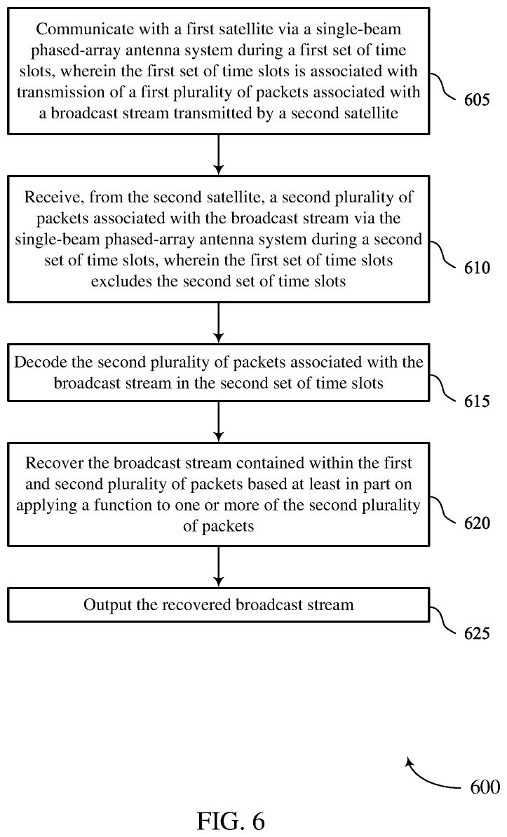

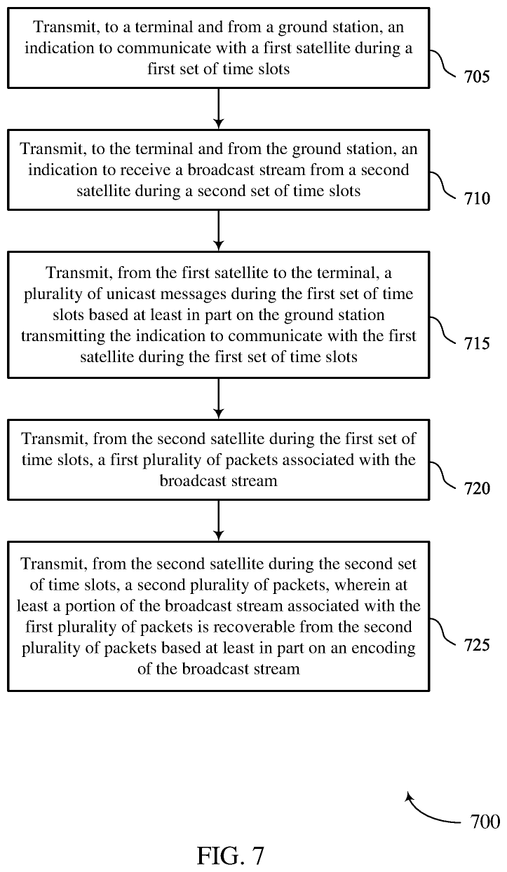

Features of the disclosure are initially described in the context of systems and dies as described with reference to FIGS. 1 and 2. Features of the disclosure are described in the context of a terminal, a beamforming scheme, and a duty cycle adjustment scheme as described with reference to FIGS. 3 through 5. These and other features of the disclosure are further illustrated by and described with reference to an apparatus diagram and flowcharts that relate to unicast and broadcast communications using phased-array antenna as described with reference to FIGS. 6 and 7.

FIG. 1 illustrates an example of a network 100 that supports unicast and broadcast communications using a phased-array antenna in accordance with examples as disclosed herein. The network 100 may include a first satellite 105-a, a second satellite 105-b, and a terminal 110, which may include an antenna system 135 (e.g., a single-beam phased-array antenna system).

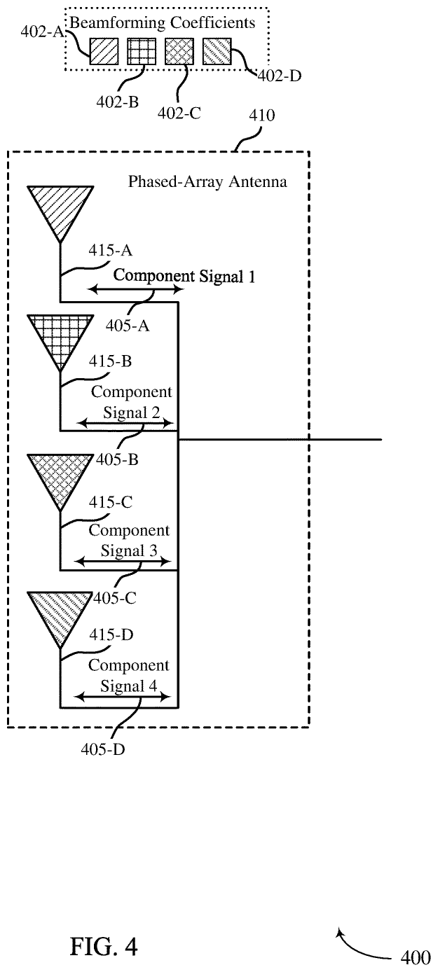

In some examples, first satellite 105-a may communicate one or more unicast messages 120 with the terminal 110 via transmit beam 125-a. Additionally, second satellite 105-b may transmit broadcast stream 115 via transmit beam 125-b. The antenna system 135 may communicate the one or more unicast messages 120 via beam 130-a and packets of the broadcast stream 115 via beam 130-b. In some examples, the antenna system may be a single-beam phased-array antenna system, which may receive the broadcast stream 115 and communicate the one or more unicast messages 120. For instance, during a first set of time slots, the single-beam phased-array antenna system may form beam 130-a to communicate the one or more unicast messages 120 and, during a second set of time slots, the single-beam phased-array antenna system may form beam 130-b to receive packets of the broadcast stream 115. The antenna system 135 may include a single phased array antenna. Alternatively, the antenna system 135 may include separate antennas that may be used at different times. In some cases, the antenna system 135 may include a single transceiver, and thus may be capable of communicating via a single beam (e.g., using a single antenna or a single beam of a phased array antenna) at a time. For instance, during the first set of time slots, antenna system 135 may form beam 130-a to communicate the one or more unicast messages 120 and, during the second set of time slots, the antenna system 135 may form beam 130-b to receive packets of the broadcast stream 115. In examples using more than one antenna, a first antenna may be deactivated during the second set of time slots and a second antenna may be deactivated during the first set of time slots. In some examples, the first antenna and the second antenna may be selectively coupled with a same transceiver and the terminal 110 may switch between coupling the first antenna with the transceiver and coupling the second antenna with the transceiver. In some examples, second satellite 105-b may communicate with ground station 140-b via communication link 160.

Where antenna system 135 includes a single-beam phased-array antenna system, a first set of beamforming coefficients may be applied during the first set of time slots. The first set of beamforming coefficients may convert between component signals of the single-beam phased-array antenna system and a first beam signal, where the first beam signal is associated with communicating with the first satellite 105-a. Similarly, a second set of beamforming coefficients may be applied during the second set of time slots to the component signals from the antenna system 135 to obtain a second beam signal associated with communicating with second satellite 105-b. In some such examples, terminal 110 may output the broadcast stream based on applying the second set of beamforming coefficients during the second set of time slots. Additional details may be described herein, for instance, with reference to FIG. 4.

Network 100 may include ground station 140-a, which may configure various communication parameters for terminal 110, first satellite 105-a, or second satellite 105-b. In some examples, ground station 140-a may transmit, to terminal 110 (e.g., via first satellite 105-a), an indication 145 of the first set of time slots and the second set of time slots. In some examples, terminal 110 (e.g., or another device, such as first satellite 105-a or second satellite 105-b) may transmit to ground station 140-a (e.g., via first satellite 105-a) an indication 150 of a link metric, a coding metric, or both (e.g., an indication of a coding scheme, such as a linear rateless coding scheme). Additionally or alternatively, terminal 110 may transmit to ground station 140-a (e.g., via first satellite 105-a) an indication 155 of a duty cycle associated with the first set of time slots. In some examples, the ground station 140-a may determine the first set of time slots and/or the second set of time slots based on the indication 150 of the link metric, the coding metric, or both and/or the indication 155 of the duty cycle. In some examples, the indication 155 of the duty cycle may enable ground station 140 to adjust a previously configured duty cycle. For instance, prior to receiving the indication 155, the ground station 140-a may indicate a third set of time slots for communicating unicast messages that is associated with a second duty cycle (e.g., configured by a previous indication 155 or pre-configured), and after receiving the indication 155 of the updated duty cycle, the ground station 140-a may indicate the first set of time slots for communicating unicast messages that is associated with the first duty cycle.

In some examples, second satellite 105-b may transmit a first set of packets using the first set of time slots and may transmit a second set of packets using the second set of time slots. In some such examples, terminal 110 may refrain from receiving the first set of packets, as terminal 110 may be communicating the one or more unicast messages 120 during the first set of time slots. In order to enable terminal 110 to recover the portion of the broadcast stream associated with the first set of packets, the second satellite 105-b may encode the first set of packets and the second set of packets with a level of redundancy such that the terminal 110 may recover the portion of the broadcast stream associated with the first set of packets based on the second set of packets (e.g., by applying a function to the second set of packets, such as a function associated with a linear rateless code). Additional details may be described herein, for instance, with reference to FIG. 3.

In some examples, ground station 140-a and satellites 105-a and 105-b may communicate with a second terminal 110. For instance, ground station 140-a may transmit, to the second terminal, an indication (e.g., an indication 145) to communicate with first satellite 105-a during a third set of time slots and to communicate with second satellite 105-b during a fourth set of time slots. Additionally, first satellite 105-a may communicate, with the antenna system 135, a second set of unicast messages 120 during the third set of time slots based on the ground station 140-a transmitting the indication to communicate with first satellite 105-a during the third set of time slots. Second satellite 105-b may transmit a third set of packets during the third set of time slots and a fourth set of packets during the fourth set of time slots, where the third set of time slots may be different than the first set of time slots. In some cases, a first quantity of time slots of the first set of time slots over a duration may be the same as a second quantity of time slots of the third set of time slots over the duration. Thus, the first set of packets may differ from the third set of packets and/or the second set of packets may differ from the fourth set of packets (e.g., the first set of time slots may differ from the third set of time slots and/or the second set of time slots may differ from the fourth set of time slots). Accordingly, the terminal 110 and the second terminal 110 may each receive packets associated with different parts of the broadcast stream. However, both the terminal 110 and the second terminal 110 may be able to recover the broadcast stream from the first set of packets and the third set of packets, respectively, even though the first set of packets may differ from the third set of packets.

In some examples, ground station 140-a may determine the first set of time slots based on a coding scheme used by the second satellite 105-b for encoding the broadcast stream 115. For example, the second satellite 105-b may use an existing network coding scheme and ground station 140-a-may determine the first set of time slots such that the broadcast stream can be recovered using the packets of the broadcast stream received in a second set of time slots that excludes the first set of time slots. In some such examples, unicast system timing may be synchronized to the broadcast frame timing.

In other examples, the coding scheme used by the second satellite 105-b for encoding the broadcast stream 115 may be configured to provide a given network coding redundancy based on an identified throughput of unicast messages 120 (e.g., quantity or data rate for unicast packets). For example, a data rate for unicast messages for each terminal may be determined, which may correspond to a duty cycle of the unicast messages. A coding scheme may be configured to provide coding redundancy that can allow for recovery of the broadcast stream where packets are missing at the duty cycle.

FIG. 2 illustrates an example of a communication scheme 200 that supports unicast and broadcast communications using phased-array antenna in accordance with examples as disclosed herein. In some examples, communication scheme 200 may be implemented by one or more aspects of network 100. For instance, unicast messages 205 may be examples of the one or more unicast messages 120 communicated between first satellite 105-a and terminal 110 as described with reference to FIG. 1 and sets of packets 210 (e.g., packet sets (PS)) may be examples of packets of broadcast stream 115 transmitted by satellite 105-b as described with reference to FIG. 1.

In some examples, a terminal (e.g., terminal 110 as described with reference to FIG. 1) and one or more satellites (e.g., first satellite 105-a and second satellite 105-b as described with reference to FIG. 1) may communicate one or more packets over each time slot (e.g., time slots 212-a, 212-b, 212-c, 212-d, 212-e, 212-f, and 212-g). In some examples, a first satellite may transmit a first message 205-a over time slot 212-a, a second message 205-b over time slot 212-d, and a third message 205-c over time slot 212-g. Each message 205 may carry one or more packets associated with unicast signaling. Additionally, a second satellite may transmit a first set of packets 210-a of a broadcast stream over time slot 212-a, a second set of packets 210-b of the broadcast stream over time slot 212-b, third set of packets 210-c of the broadcast stream over time slot 212-c, a fourth set of packets 210-d of the broadcast stream over time slot 212-d, fifth set of packets 210-e of the broadcast stream over time slot 212-e, sixth set of packets 210-f of the broadcast stream over time slot 212-f, and seventh set of packets 210-g of the broadcast stream over time slot 212-g. The packets of the broadcast stream may be network coded such that missing packets may be recovered from other packets. For example, groups of packets may be network coded such that the information in any one missing packet may be recovered by applying a function to the information contained in the other packets of the group. In one example, at least one packet of the group of packets includes parity information for other packets of the group.

In some examples, the terminal may use a first beam to receive messages 205-a, 205-b, and 205-c during time slots 212-a, 212-d, and 212-g, respectively, and may use a second beam to receive second set of packets 210-b, third set of packets 210-c, fifth set of packets 210-e, and sixth set of packets 210-f during time slots 212-b, 212-c, 212-e, and 212-f. By using the first beam and refraining from using the second beam during time slots 212-a, 212-d, and 212-g, the terminal may fail to receive first set of packets 210-a, fourth set of packets 210-d, and seventh set of packets 210-g. However the terminal may recover the broadcast stream information in first set of packets 210-a, fourth set of packets 210-d, and seventh set of packets 210-g using the successfully received sets of packets 210-b, 210-c, 210-e, and 210-f. For instance, the terminal may decode sets of packets 210-b, 210-c, 210-e, and 210-f. At 220, the terminal may recover the broadcast stream information in first set of packets 210-a, fourth set of packets 210-d, and seventh set of packets 210-g (e.g., by applying a function to second set of packets 210-b, third set of packets 210-c, fifth set of packets 210-e, and sixth set of packets 210-f). For example, first set of packets 210-a through seventh set of packets 210-g may be network coded such that any one of the packets may be recoverable using the information in one or more of the other packets. For example, the broadcast stream may be recoverable with any combination of a certain quantity (e.g., up to three) of first set of packets 210-a through seventh set of packets 210-g not being received.

FIG. 3 illustrates an example of an antenna system 300 that supports unicast and broadcast communications using phased-array antenna in accordance with examples as disclosed herein. Antenna system 300 may be, for example, a single-beam phased array antenna system. In some examples, antenna system 300 may be an example of one or more aspects of antenna system 135, and may be implemented in a terminal 110 of network 100. For instance, antenna system 300 may be an example of aspects of a terminal 110 as described with reference to FIG. 1. Antenna system 300 may include first antenna 305-a, second antenna 305-b, a bus 315, a beamforming component 320, a decoder 325, and transceiver 330. Additionally, first antenna 305-a may include a set of elements 310-a (e.g., antenna elements) and second antenna 305-b may include a second set of elements 310-b (e.g., antenna elements). First antenna 305-a, second antenna 305-b, beamforming component 320, transceiver 330, and decoder 325 may form a single-beam phased array antenna system (e.g., may support a single beam at a time). In some examples, second antenna 305-b may not be present.

First antenna 305-a may be configured to communicate (e.g., transmit and/or receive) unicast messages from a first satellite. For instance, first antenna 305-a may form a first beam for communicating the unicast messages and may communicate the unicast messages using the first beam. Additionally, first antenna 305-a may be configured to receive packets containing a broadcast stream from a second satellite. For instance, first antenna 305-a may form a second beam for receiving the packets and may receive at least a portion of the packets using the second beam. First antenna 305-a may be a phased-array antenna.

Second antenna 305-b may be configured to receive packets containing a broadcast stream from the second satellite. For instance, second antenna 305-b may form the second beam for receiving the packets and may receive at least a portion of the packets using the second beam. In examples in which second antenna 305-b is configured to receive the packets containing the broadcast stream from the second satellite, first antenna 305-a may not be configured to receive the packets. Alternatively, in some such examples in which the first-phased-array antenna 305-a is configured to receive the packets, second phased-array antenna 305-b may not be present or may not be configured to receive the packets.

Beamforming component 320 may be capable of forming a single beam at a time. For example, beamforming component 320 may include beamforming or processing circuitry configured to support generating beamforming coefficients for a single beam. In some cases, a beamforming component supporting a single beam may be lower complexity (e.g., and lower cost) than a beamforming component that supports multiple beams concurrently. In some examples, beamforming component 320 may be configured to apply, during a first set of time slots, a first set of beamforming coefficients to convert between components signals of the first set of antenna elements 310-a and a first beam associated with communicating with a first satellite. In some such examples, the first set of time slots may be associated with transmission of a first set of packets associated with a broadcast stream transmitted by a second satellite. Additionally, beamforming component 320 may be configured to apply, during a second set of time slots, a second set of beamforming coefficients to the component signals from the first set of antenna elements 310-a or the second set of antenna elements 310-b to obtain a second beam signal from the second satellite, where the first set of time slots excludes the second set of time slots.

In some examples, decoder 325 may be configured to decode a second set of packets associated with the broadcast stream that are received via the second beam signal in the second set of time slots. In some such examples, the decoder may be configured to recover the broadcast stream contained within the first and the second set of packets based on applying a function to one or more of the second set of packets. For instance, in one example, the second satellite may transmit a first packet (e.g., “Packet A”), a second packet (e.g., “Packet B”), a third packet (e.g., “Packet C”), and a fourth packet (e.g., “Packet D”) that includes redundancy information for the first packet, the second packet, and the third packet e.g., Packet D may be given by A⊗B⊗C). In examples in which the terminal receives Packet A, Packet C, and Packet D, the terminal may recover packet B by performing a function of Packet A, Packet C, and Packet D (e.g., performing an XOR of Packet A, Packet C, and Packet D).

In some examples, the first set of time slots includes a first time slot, a second time slot, and a third time slot, where a first total number of time slots between the first time slot and the second time slot is different than a second total number of time slots between the second time slot and the third time slot. Additionally or alternatively, the first set of time slots may be associated with a first duty cycle over a first duration and, may be associated with a second duty cycle over a second duration that is different than the first duty cycle. In some such examples, the first total number of time slots being different than the second total number of time slots is based on the first set of time slots being associated with the first duty cycle over the first duration and being associated with the second duty cycle over the second duration.

In some examples, transceiver 330 may communicate, with a ground station (e.g., a ground station 140-a as described with reference to FIG. 1), an indication of the second duty cycle. In some such examples, the first total number of time slots may be different than the second total number of time slots based on communicating the indication of the second duty cycle. In some examples, a ratio of a first total number of time slots in the first set of time slots to a second total number of time slots in the first set of time slots and the second set of time slots over a duration is based on a parameter corresponding to a level of redundancy associated with the broadcast stream. In some examples, transceiver 330 may transmit an indication of a coding scheme, a link metric, a duty cycle, or any combination thereof to a ground station.

FIG. 4 illustrates an example of a beamforming scheme 400 that supports unicast and broadcast communications using phased-array antenna in accordance with examples as disclosed herein. In some examples, beamforming scheme 400 may be implemented by one or more aspects of antenna system 300. For instance, phased-array antenna 410 may be an example of first antenna 305-a or second antenna 305-b as described with reference to FIG. 3 and elements 415-a, 415-b, 415-c, and 415-d may be examples of elements 310-a or 310-b as described with reference to FIG. 3.

In some examples, phased-array antenna 410 may communicate one or more component signals. For instance, element 415-a may communicate a first component signal 405-a, element 415-b may communicate a second component signal 405-b, element 415-c may communicate a third component signal 405-c, and element 415-d may communicate a fourth component signal 405-d. In some examples, phased-array antenna 410 may apply a set of beamforming coefficients to convert between component signals 405-a, 405-b, 405-c, and 405-d and a beam signal. For instance, to receive a beam, phased-array antenna 410 may apply beamforming coefficient 402-a to component signal 405-a, beamforming coefficient 402-b to component signal 405-b, beamforming coefficient 402-c to component signal 405-c, and beamforming coefficient 402-d to component signal 405-d. Each beamforming coefficient may have an associated magnitude and/or phase.

To transmit a beam, phased-array antenna 410 may apply a set of beamforming coefficients to a beam signal to generate component signals 405-a, 405-b, 405-c, and 405-d. For instance, phased-array antenna 410 may apply beamforming coefficient 402-a to the beam signal to generate component signal 405-a, beamforming coefficient 402-b to the beam signal to generate component signal 405-b, beamforming coefficient 402-c to the beam signal to generate component signal 405-c, and beamforming coefficient 402-d to the beam signal to generate component signal 405-d. The component signals 405-a, 405-b, 405-c, and 405-d may then be transmitted via respective elements 415-a, 415-b, 415-c, and 415-d.

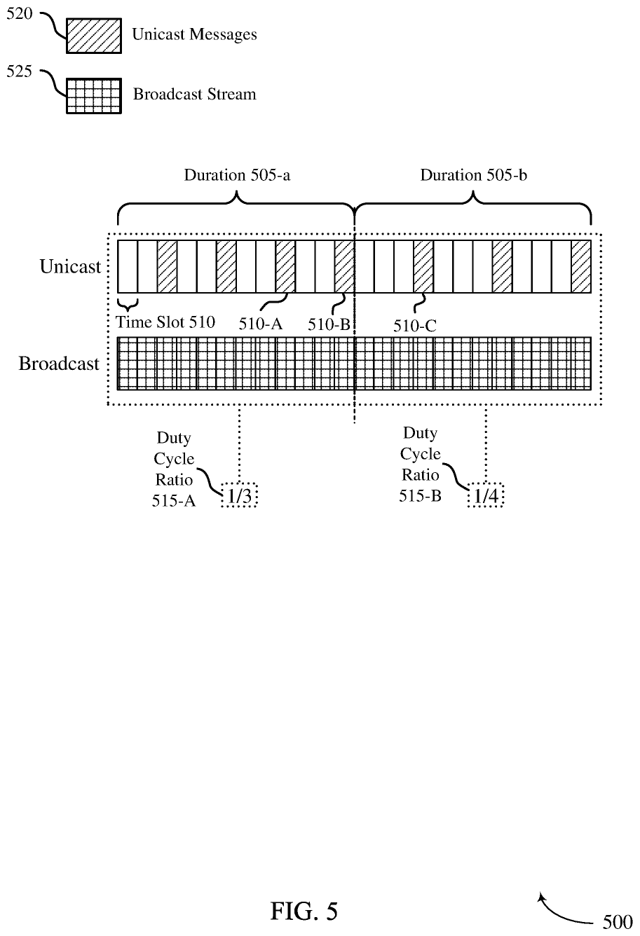

FIG. 5 illustrates an example of a duty cycle adjustment scheme 500 that supports unicast and broadcast communications using phased-array antenna in accordance with examples as disclosed herein. In some examples, duty cycle adjustment scheme 500 may be implemented by one or more aspects of network 100. For instance, duty cycle adjustment scheme 500 may represent a scheme depicting the adjustment of a duty cycle for unicast messages communicated with a first satellite 105-a.

During a first duration 505-a (e.g., a first duration that spans 12 time slots 510), a first satellite may communicate a first set of unicast messages 520 with a terminal. For instance, in the present example, the first satellite may communicate the first set of unicast messages 520 with the terminal over four time slots 510 within the first duration 505-a. For example, the terminal may use a phased-array antenna to receive a beam from the first satellite over the four time slots carrying unicast messages 520 during duration 505-a, and may not receive packets of the broadcast stream 525 transmitted during these four slots. During the other eight time slots 510 of first duration 505-a, the terminal may receive packets of the broadcast stream 525. As described above, the terminal may recover any packets of the broadcast stream 525 that were not received as a result of communicating the unicast messages 520. As the unicast messages 520 are communicated over four time slots 510 of the first duration 505-a, a duty cycle ratio 515-a for the unicast messages may be equal to ⅓ (e.g., 4 time slots 510 out of 12 are for unicast messages 520). During the eight time slots that the first satellite is not communicating with the terminal during the first duration 505-a, the first satellite may communicate other unicast messages with other terminals. For example, the first satellite may communicate with two other terminals over the frequency channel shown in FIG. 5 during the first duration 505-a, each having the same duty cycle (e.g., ⅓) of unicast messages. Because each packet of the broadcast stream 525 may be recovered using information from other packets, each of the terminals receiving unicast messages may also recover the broadcast stream.

After duration 505-a, the duty cycle may be adjusted for a second duration 505-b (e.g., due to the terminal receiving or transmitting the unicast messages 520 transmitting an updated duty cycle value to the ground station). Accordingly, in the present example, the first satellite may communicate a second set of unicast messages 520 with the terminal over three time slots 510 within the second duration 505-b. For example, the terminal may use the phased-array antenna to receive the beam from the first satellite over the three time slots carrying unicast messages 520 during duration 505-b, and may not receive packets of the broadcast stream 525 transmitted during these three slots. During the other nine time slots 510 of second duration 505-b, the terminal may receive packets of the broadcast stream. As the unicast messages 520 are communicated over three time slots 510 of the second duration 505-b, a duty cycle ratio 515-b for the unicast messages may be equal to ¼ (e.g., 3 time slots 510 out of 12 are for unicast messages 520). In some examples, the duty cycle may change from duration 505-a to duration 505-b based on a corresponding change in link conditions (e.g., a change in SNR or SINR). For instance, as the link conditions deteriorate (e.g., SNR or SINR decreases), a value of the duty cycle may decrease to increase an amount of redundant information of the broadcast stream 525 received by the terminal. Additionally or alternatively, the change in duty cycle may occur because of other factors. For example, a terminal may request a lower data rate during the second duration 505-b, or a quantity of terminals being served by a satellite transmitting unicast messages may change. For example, during duration 505-a, the satellite may support unicast messages having a duty cycle of ⅓ to three terminals (e.g., over the frequency channel shown in FIG. 5), while during duration 505-b, the satellite may support unicast messages having a duty cycle of ¼ to four terminals (e.g., over the frequency channel).

In some examples, a first total number of time slots 510 between a first time slot 510-a for communicating unicast messages 520 and a second time slot 510-b (e.g., 2 time slots) for communicating unicast messages 520 may be different than a second total number of total time slots 510 between the second time slot 510-b and a third time slot 510-c for communicating unicast messages 520 (e.g., 3 time slots). Additionally or alternatively, duty cycle ratio 515-a (e.g., a ratio of time slots for communicating unicast messages to a total number of time slots) for first duration 505-a may differ from duty cycle ratio 515-b for second duration 505-b.

FIG. 6 shows a flowchart illustrating a method 600 that supports unicast and broadcast communications using phased-array antenna in accordance with examples as disclosed herein. The operations of method 600 may be implemented by a terminal or its components as described herein. For example, the operations of method 600 may be performed by a terminal as described with reference to FIGS. 1 through 5. In some examples, a terminal may execute a set of instructions to control the functional elements of the device to perform the described functions. Additionally, or alternatively, the terminal may perform aspects of the described functions using special-purpose hardware.

At 605, the method may include communicating with a first satellite via a single-beam phased-array antenna system during a first set of time slots, where the first set of time slots is associated with transmission of a first plurality of packets associated with a broadcast stream transmitted by a second satellite. The operations of 605 may be performed in accordance with examples as disclosed herein.

At 610, the method may include receiving, from the second satellite, a second plurality of packets associated with the broadcast stream via the single-beam phased-array antenna system during a second set of time slots, where the first set of time slots excludes the second set of time slots. The operations of 610 may be performed in accordance with examples as disclosed herein.

At 615, the method may include decoding the second plurality of packets associated with the broadcast stream in the second set of time slots. The operations of 615 may be performed in accordance with examples as disclosed herein.

At 620, the method may include recovering the broadcast stream contained within the first and second plurality of packets based at least in part on applying a function to one or more of the second plurality of packets. The operations of 620 may be performed in accordance with examples as disclosed herein.

At 625, the method may include outputting the recovered broadcast stream. The operations of 625 may be performed in accordance with examples as disclosed herein.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

FIG. 7 shows a flowchart illustrating a method 700 that supports unicast and broadcast communications using phased-array antenna in accordance with examples as disclosed herein. The operations of method 700 may be implemented by a network or its components as described herein. For example, the operations of method 700 may be performed by a network as described with reference to FIGS. 1 through 5. In some examples, a network may execute a set of instructions to control the functional elements of the device to perform the described functions. Additionally, or alternatively, the network may perform aspects of the described functions using special-purpose hardware.

At 705, the method may include transmitting, to a terminal and from a ground station, an indication to communicate with a first satellite during a first set of time slots. The operations of 705 may be performed in accordance with examples as disclosed herein.

At 710, the method may include transmitting, to the terminal and from the ground station, an indication to receive a broadcast stream from a second satellite during a second set of time slots. The operations of 710 may be performed in accordance with examples as disclosed herein.

At 715, the method may include transmitting, from the first satellite to the terminal, a plurality of unicast messages during the first set of time slots based at least in part on the ground station transmitting the indication to communicate with the first satellite during the first set of time slots. The operations of 715 may be performed in accordance with examples as disclosed herein.

At 720, the method may include transmitting, from the second satellite during the first set of time slots, a first plurality of packets associated with the broadcast stream. The operations of 720 may be performed in accordance with examples as disclosed herein.

At 725, the method may include transmitting, from the second satellite during the second set of time slots, a second plurality of packets, where at least a portion of the broadcast stream associated with the first plurality of packets is recoverable from the second plurality of packets based at least in part on an encoding of the broadcast stream. The operations of 725 may be performed in accordance with examples as disclosed herein.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method, comprising:
communicating a unicast stream with a first satellite via a single-beam phased-array antenna system during a first set of time slots, wherein the first set of time slots is associated with transmission of a first plurality of packets associated with a broadcast stream transmitted by a second satellite;
receiving, from the second satellite, a second plurality of packets associated with the broadcast stream via the single-beam phased-array antenna system during a second set of time slots, wherein the first set of time slots excludes the second set of time slots;
decoding the second plurality of packets associated with the broadcast stream in the second set of time slots;
recovering the broadcast stream contained within the first and second plurality of packets based at least in part on applying a function to one or more of the second plurality of packets; and
outputting the recovered broadcast stream.

2. The method of claim 1, further comprising:
applying, during the first set of time slots, a first set of beamforming coefficients to convert between component signals of the single-beam phased-array antenna system and a first beam signal, the first beam signal associated with communicating with the first satellite; and
applying, during the second set of time slots, a second set of beamforming coefficients to the component signals from the single-beam phased-array antenna system to obtain a second beam signal associated with communicating with the second satellite, wherein outputting the broadcast stream is based at least in part on applying the second set of beamforming coefficients during the second set of time slots.

3. The method of claim 1, wherein the first set of time slots comprises a first time slot, a second time slot, and a third time slot, and wherein a first total number of time slots between the first time slot and the second time slot is different than a second total number of time slots between the second time slot and the third time slot.

4. The method of claim 3, wherein over a first duration, the first set of time slots is associated with a first duty cycle, and, over a second duration, the first set of time slots is associated with a second duty cycle different than the first duty cycle, and wherein the first total number of time slots being different than the second total number of time slots is based at least in part on the first set of time slots being associated with the first duty cycle over the first duration and being associated with the second duty cycle over the second duration.

5. The method of claim 4, further comprising:
communicating an indication of the second duty cycle, wherein the first total number of time slots being different than the second total number of time slots is based at least in part on communicating the indication of the second duty cycle.

6. The method of claim 1, wherein a ratio of a first total number of time slots in the first set of time slots to a second total number of time slots in the first set of time slots and the second set of time slots over a duration is based at least in part on a parameter corresponding to a level of redundancy associated with the broadcast stream.

7. A method, comprising:
transmitting, to a terminal and from a ground station, an indication to communicate with a first satellite during a first set of time slots;
transmitting, to the terminal and from the ground station, an indication to receive a broadcast stream from a second satellite during a second set of time slots;
transmitting, from the first satellite to the terminal, a plurality of unicast messages during the first set of time slots based at least in part on the ground station transmitting the indication to communicate with the first satellite during the first set of time slots;
transmitting, from the second satellite during the first set of time slots, a first plurality of packets associated with the broadcast stream; and
transmitting, from the second satellite during the second set of time slots, a second plurality of packets, wherein at least a portion of the broadcast stream associated with the first plurality of packets is recoverable from the second plurality of packets based at least in part on a level of redundancy of an encoding of the broadcast stream and a duty cycle of the first set of time slots.

8. The method of claim 7, further comprising:
transmitting, to a second terminal and from the ground station, an indication to communicate with the first satellite during a third set of time slots;
transmitting, to the second terminal and from the ground station, an indication to receive the broadcast stream from a second satellite during a fourth set of time slots;
transmitting, from the first satellite to the second terminal, a second plurality of unicast messages during the third set of time slots based at least in part on the ground station transmitting the indication to communicate with the first satellite during the third set of time slots;
transmitting, from the second satellite during the third set of time slots, a third plurality of packets associated with the broadcast stream; and
transmitting, from the second satellite during the fourth set of time slots, a fourth plurality of packets, wherein at least a second portion of the broadcast stream associated with the third plurality of packets is recoverable from the fourth plurality of packets based at least in part on the encoding of the broadcast stream.

9. The method of claim 7, further comprising:
receiving, at the ground station, an indication of a coding scheme associated with the broadcast stream; and
determining, at the ground station, the first set of time slots based at least in part on the indication of the coding scheme.

10. The method of claim 7 through 9, further comprising:
receiving, at the ground station, an indication of a link metric between the second satellite and the terminal; and
determining, at the ground station, the first set of time slots based at least in part on the indication of the link metric.

11. The method of claim 7, wherein the first set of time slots comprises a first time slot, a second time slot, and a third time slot, and wherein a first total number of time slots between the first time slot and the second time slot is different than a second total number of time slots between the second time slot and the third time slot.

12. The method of claim 11, wherein over a first duration, the first set of time slots is associated with a first duty cycle and, over a second duration, the first set of time slots is associated with a second duty cycle different than the first duty cycle, and wherein the first total number of time slots being different than the second total number of time slots is based at least in part on the first set of time slots being associated with the first duty cycle over the first duration and being associated with the second duty cycle over the second duration.

13. The method of claim 12, further comprising:
communicating, with the terminal, an indication of the second duty cycle, wherein the first total number of time slots being different than the second total number of time slots is based at least in part on communicating the indication of the second duty cycle.

14. The method of claim 7, wherein a ratio of a first total number of time slots in the first set of time slots to a second total number of time slots in the first set of time slots and the second set of time slots over a duration is based at least in part on a parameter corresponding to the level of redundancy of the encoding of the broadcast stream.

15-27. (canceled)
